(19) United States
(12) Patent Application Publication
(10) Pub. No.: US 2021/0281339 A1
(43) Pub. Date: Sep. 9, 2021

(54) COMMUNICATION SYSTEM AND SLAVE DEVICE

(71) Applicant: MITSUBISHI ELECTRIC CORPORATION, Tokyo (JP)

(72) Inventor: Taichi SAKAUE, Tokyo (JP)

(73) Assignee: MITSUBISHI ELECTRIC CORPORATION, Tokyo (JP)

(21) Appl. No.: 16/607,397

(22) PCT Filed: Jun. 27, 2017
(86) PCT No.: PCT/JP2017/023645

§ 371 Date: Oct. 23, 2019

(51) Int. Cl. H04J 3/06

(52) U.S. Cl. CPC H04J 3/0638; H04L 7/0033; H04J 3/0682

(57) ABSTRACT

A grand master device (GM) (10) and a slave device (S1) (20) are connected via a general-purpose hub (HUB) (30) whose relay delay is not constant. The grand master device (GM) (10), at a timing for transmitting a Sync frame for time synchronization, acquires current time as transmission time of the Sync frame, acquires a count value of a master counter as a transmission count value, stores the transmission time and the transmission count value in the Sync frame, and transmits the Sync frame. The slave device (S1) (20) receives the Sync frame, acquires reception time of the Sync frame and a reception count value which is a count value of a slave counter at the reception time, and corrects time of the slave device (S1) (20), using the transmission time, the transmission count value, the reception time and the reception count value.

### TECHNICAL FIELD

The present invention relates to a communication system including a master device and a slave device.

### BACKGROUND ART

In recent years, a network device equipped with a time synchronization protocol such as IEEE1588 or IEEE802.1AS is prevailing.

In IEEE1588 or IEEE802.1AS, a master device (also called as a grand master device hereinafter) which becomes a time source transmits a Sync frame in which time information is stored to a slave device. When the slave device receives the Sync frame, the slave device acquires the time information of the master device from the Sync frame. Then, the slave device corrects time of the slave device. Thereby, the slave device can synchronize with the master device.

The protocol of IEEE1588 is described, using FIG. 14. (1)-(9) below corresponds to (1)-(9) in FIG. 14.

(1) The grand master device (GM) acquires a time stamp t1 of transmission time (called simply as transmission time t1 hereinafter) when transmitting the Sync frame, and stores the transmission time t1 in the Sync frame. Then, the grand master device (GM) transmits the Sync frame in which the transmission time t1 is stored to the slave device (S1). In FIG. 14, the Sync frame in which the transmission time t1 is stored is written as Sync (t1).

(2) When the slave device (S1) receives the Sync frame from the grand master device (GM), the slave device (S1) acquires a time stamp t2 of reception time of the Sync frame (called simply as reception time t2 hereinafter), and retains the reception time t2. Also, the slave device (S1) extracts the transmission time t1 stored in the Sync frame, and retains the transmission time t1.

(3) The slave device (S1) transmits a DelayReq frame which is a propagation delay measurement request frame to the grand master device (GM). At this time, the slave device (S1) acquires a time stamp t3 of transmission time of the DelayReq frame (called simply as transmission time t3 hereinafter), and retains the transmission time t3.

(4) The grand master device (GM) receives the DelayReq frame from the slave device (S1). The grand master device (GM) acquires a time stamp t4 of reception time of the DelayReq frame (called simply as reception time t4 hereinafter), and retains the reception time t4.

(5) The grand master device (GM) stores the reception time t4 in the DelayResp frame which is a propagation delay measurement response frame, and transmits the DelayResp frame in which the reception time t4 is stored to the slave device (S1). In FIG. 14, the DelayResp frame in which the reception time t4 is stored is written as DelayResp (t4).

(6) The slave device (S1) extracts the reception time t4 stored in the DelayResp frame, and retains the reception time t4.

(7) The slave device (S1) calculates propagation delay time between the grand master device (GM) and the slave device (S1), using the retaining transmission time t1, the retaining reception time t2, the retaining transmission time t3, and the retaining reception time t4 in the following manner.

D={(t4−t1)+(t2−t3)}/2 Propagation delay time:

(8) The grand master device (GM) acquires, at a certain time point, a time stamp t_tx of transmission starting time (called simply as transmission starting time t_tx hereinafter), stores the transmission starting time t_tx in the Sync frame, and transmits the Sync frame to the slave device (S1). In FIG. 14, the Sync frame in which the transmission starting time t_tx is stored is written as Sync(t_tx).

(9) On reception of Sync(t_tx), the slave device (S1) acquires a time stamp t_rx of reception time of Sync(t_tx) (called simply as reception time t_rx hereinafter), and retains the reception time t_rx. In addition, the slave device (S1) calculates a time difference between the grand master device (GM) and the slave device (S1) in the following manner, from the retaining transmission starting time t_tx, the retaining reception time t_rx and the propagation delay time calculated in (7) described above, and corrects the time of the slave device (S1), using the calculated time difference.

Offset=t_tx+D−t_rx Time difference from the grand master device (GM):

These time synchronization protocols are applied to time synchronization between devices in an FA (Factory Automation) system. By performing time synchronization between the devices, real-time communication at a short communication cycle can be realized. In addition, a plurality of different communication protocols can be incorporated by time division.

### CITATION LIST

### Patent Literature

Patent Literature 1: JP2008-262292A

### Non-Patent Literature

Non-Patent Literature 1: IEEE Std 1588
Non-Patent Literature 2: IEEE Std 802.1AS

### SUMMARY OF INVENTION

### Technical Problem

In IEEE1588 or IEEE802.1AS, a propagation delay is measured at a fixed interval, and propagation delay time between devices is updated at a fixed interval. Therefore, in IEEE1588 or IEEE802.1AS, time correction is performed, using propagation delay time measured at different timing from transmission of the Sync frame. At this time, there is a case in which the propagation delay time measured at transmission of the Sync frame differs considerably from the propagation delay time measured at the different timing. In this case, the slave device (S1) cannot perform time correction accurately, and a synchronization gap occurs between the slave device (S1) and the grand master device (GM).

Such a synchronization gap occurs, for example, in a case where a switching hub which is not compliant with time synchronization (called as a general-purpose hub (HUB) hereinafter) is incorporated in a network in which time synchronization using a time synchronization protocol is performed as in FIG. 15.

When the general-purpose hub (HUB) is incorporated in the network, the relay delay time is not kept constant due to a fluctuation in processing time of firmware in the general-purpose hub (HUB) and waiting for transmission. For this reason, the slave device (S1) cannot measure the propagation delay time accurately. As a result, the slave device (S1) connected to the grand master device (GM) via the general-purpose hub (HUB) cannot calculate the time difference from the grand master device (GM) accurately.

According to the technique of Patent Literature 1, in a case where the propagation delay fluctuates, a propagation delay measurement is performed a plurality of times, and communication having the shortest communication time is assumed to be communication with no fluctuation in the propagation delay. According to the technique of Patent Literature 1, time synchronization is performed, using a propagation delay measurement value in the communication which is assumed to have no fluctuation in the propagation delay.

However, in this method, as in FIG. 15, due to a fluctuation in the relay time at the general-purpose hub (HUB), there is a case where the propagation delay time from when the grand master device (GM) transmits the Sync frame to when the slave device (S1) receives the Sync frame differs considerably from an average value of the propagation delay time calculated in advance. In this case, time corrected by the slave device (S1) differs considerably from time of the grand master device (GM). A problem of a conventional time synchronization method is described below, using FIG. 16. (1)-(6) below corresponds to (1)-(6) of FIG. 16.

(1) The grand master device (GM) and the slave device (S1) exchange a plurality of Sync frames, DelayReq frames and DelayResp frames, and calculate the propagation delay time. (In FIG. 16, an illustration of this sequence is omitted). It is assumed that the minimum propagation delay time is calculated as D_min=3, and the relay delay time of the general-purpose hub (HUB) at this time is RTmin=1.

(2) The grand master device (GM) stores a time stamp t_sync(=11) in the Sync frame at a time point of 11, and transmits the Sync frame in which t_sync(=11) is stored to the slave device (S1).

(3) It is assumed that the relay delay time when the general-purpose hub (HUB) relays the Sync frame is 3(RT=3).

(4) The slave device (S1) receives the Sync frame at a time point of t_rx=10. In addition, the slave device (S1) acquires a time stamp t_rx(=10).

(5) The slave device (S1) calculates a time difference from the grand master device (GM) (Offset_GM), using the time stamp t_sync(=11), the time stamp t_rx(=10) and the minimum propagation delay time D_min(=3) in the following manner.

Offset_GM=t_sync+D_min−t_rx=11+3−10=4

(6) The slave device (S1) performs time correction of the slave device (S1) at the time point of 11 in the following manner.

Time_c=Time+Offset_GM=11+4=15

In the procedure described above, actual time from when the grand master device (GM) transmits the Sync frame in which t_sync(=11) is stored to when the slave device (S1) receives it is D_true=5. Time in the grand master device (GM) is 17 when the slave device (S1) performs time correction. Therefore, an error of 2 occurs between the time in the slave device (S1) and the time in the grand master device (GM).

In this way, according to the conventional time synchronization method, there is a problem that if the relay delay of the general-purpose hub (HUB) being the relay device is not constant, time synchronization cannot be realized accurately.

The present invention mainly aims to solve the above problem. More specifically, the present invention aims to realize time synchronization accurately even when the relay delay of the relay device is not constant.

### Solution to Problem

A communication system according to the present invention includes a master device and a slave device connected via a relay device whose relay delay is not constant,

wherein the master device includes

a master counter which is a free-run counter; and

a transmission unit, at a timing for transmitting a time synchronization frame for time synchronization, to acquire current time as transmission time of the time synchronization frame, to acquire a count value of the master counter as a transmission count value, to store the transmission time and the transmission count value in the time synchronization frame, and to transmit the time synchronization frame to the slave device, and

wherein the slave device includes

a slave counter which is a free-run counter;

a reception unit to receive the time synchronization frame;

an acquisition unit to acquire reception time of the time synchronization frame and a reception count value which is a count value of the slave counter at the reception time; and

a time correction unit to correct time of the slave device, using the transmission time, the transmission count value, the reception time, the reception count value, a measurement propagation delay value and a delay count difference, the measurement propagation delay value being a value of propagation delay acquired from a past measurement, the delay count difference being obtained from a count value of the master counter and a count value of the slave counter which correspond to the measurement propagation delay value.

### Advantageous Effects of Invention

According to the present invention, time synchronization can be realized accurately even when a relay delay of a relay device is not constant.

### BRIEF DESCRIPTION OF DRAWINGS

FIG. 1 is a diagram illustrating an operational outline of a communication system according to a first embodiment;

FIG. 2 is a diagram illustrating an example of a time synchronization sequence according to the first embodiment;

FIG. 3 is a diagram illustrating an example of a hardware configuration of a grand master device (GM) according to the first embodiment;

FIG. 4 is a diagram illustrating an example of a functional configuration of the grand master device (GM) according to the first embodiment;

FIG. 5 is a diagram illustrating an example of a hardware configuration of a slave device (S1) according to the first embodiment;

FIG. 6 is a diagram illustrating an example of a functional configuration of the slave device (S1) according to the first embodiment;

FIG. 7 is a flowchart illustrating a count-up and time measurement flow according to the first embodiment;

FIG. 8 is a flowchart illustrating a transmission flow of a DelayReq frame according to the first embodiment;

FIG. 9 is a flowchart illustrating a reception flow of the DelayReq frame and a transmission flow of a DelayResp frame according to the first embodiment;

FIG. 10 is a flowchart illustrating a reception flow of the DelayResp frame according to the first embodiment;

FIG. 11 is a flowchart illustrating a transmission flow of a Sync frame according to the first embodiment;

FIG. 12 is a flowchart illustrating a reception flow of the Sync frame according to the first embodiment;

FIG. 13 is a flowchart illustrating a time correction flow according to the first embodiment;

FIG. 14 is a diagram illustrating a time synchronization sequence in IEEE1588;

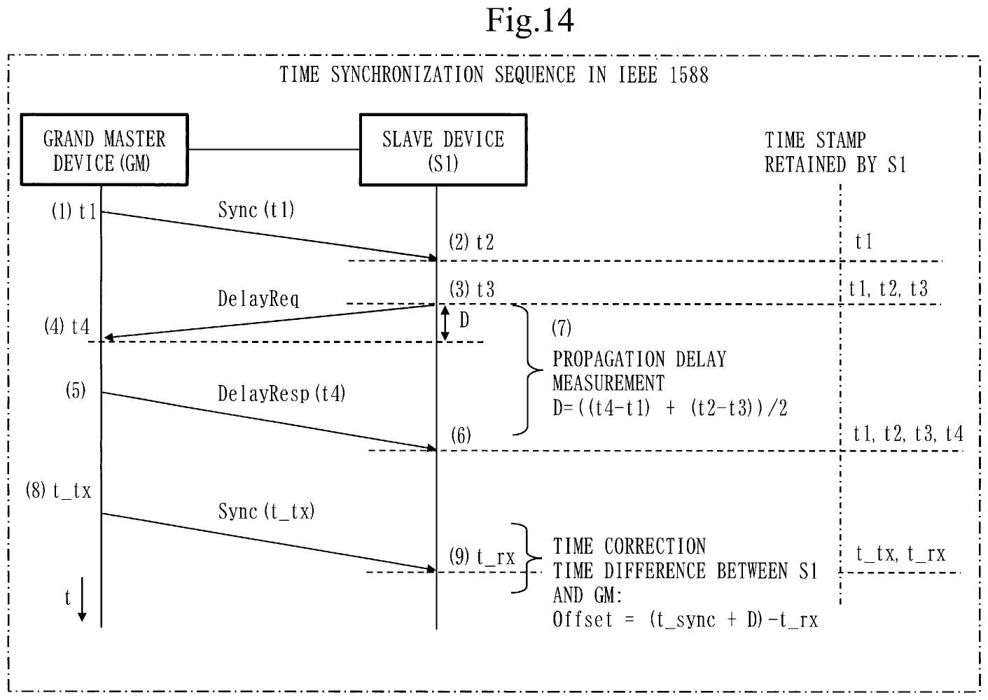

FIG. 15 is a diagram illustrating a problem of a conventional time synchronization method; and

FIG. 16 is a diagram illustrating a problem of the conventional time synchronization method.

### DESCRIPTION OF EMBODIMENTS

An embodiment of the present invention is described below, using diagrams. In descriptions and diagrams of the embodiment below, elements provided with same reference characters indicate the same elements or corresponding elements.

### First Embodiment

### ***Description of Outline***

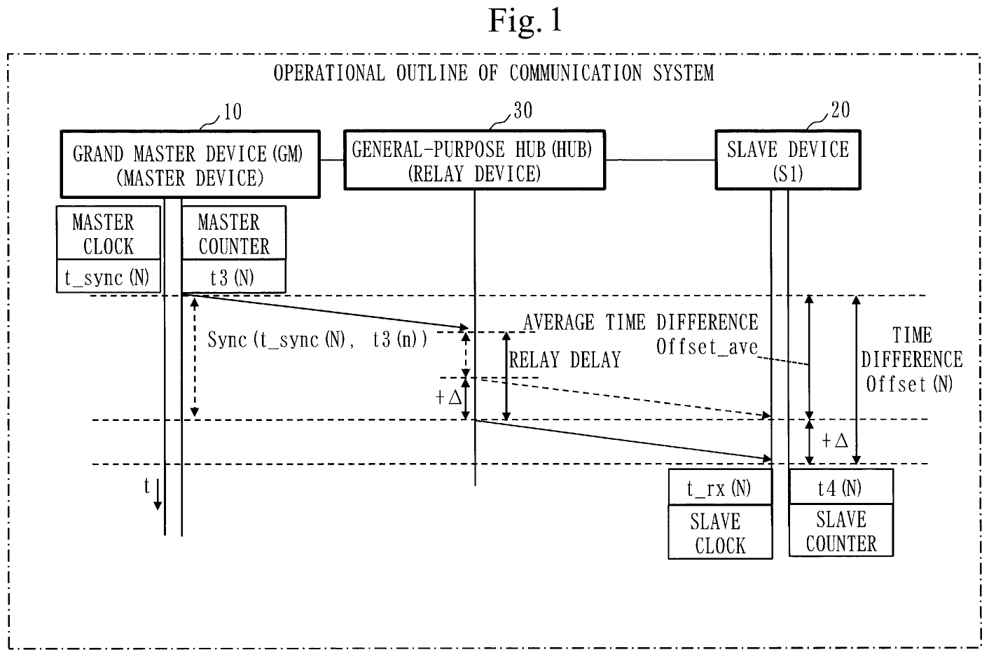

FIG. 1 illustrates an operational outline according to the present embodiment.

A communication system according to the present embodiment consists of a grand master device (GM) 10, a slave device (S1) 20 and a general-purpose hub (HUB) 30.

The grand master device (GM) 10 is a master device. The slave device (S1) 20 is a slave device. The general-purpose hub (HUB) 30 is a relay device.

The grand master device (GM) 10 and the slave device (S1) 20 are connected via the general-purpose hub (HUB) 30.

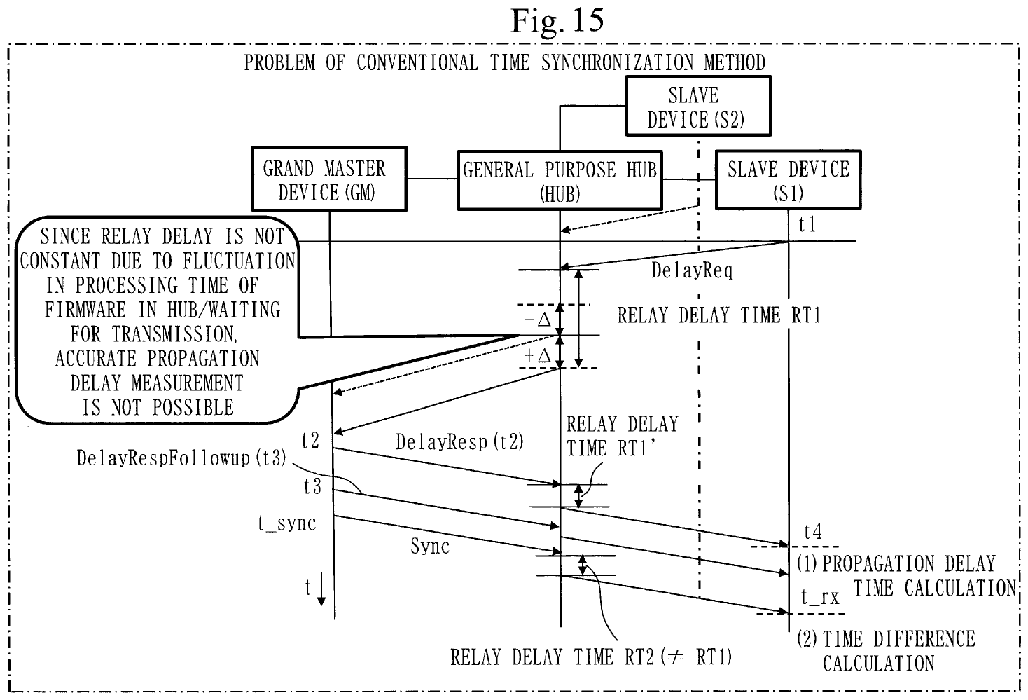

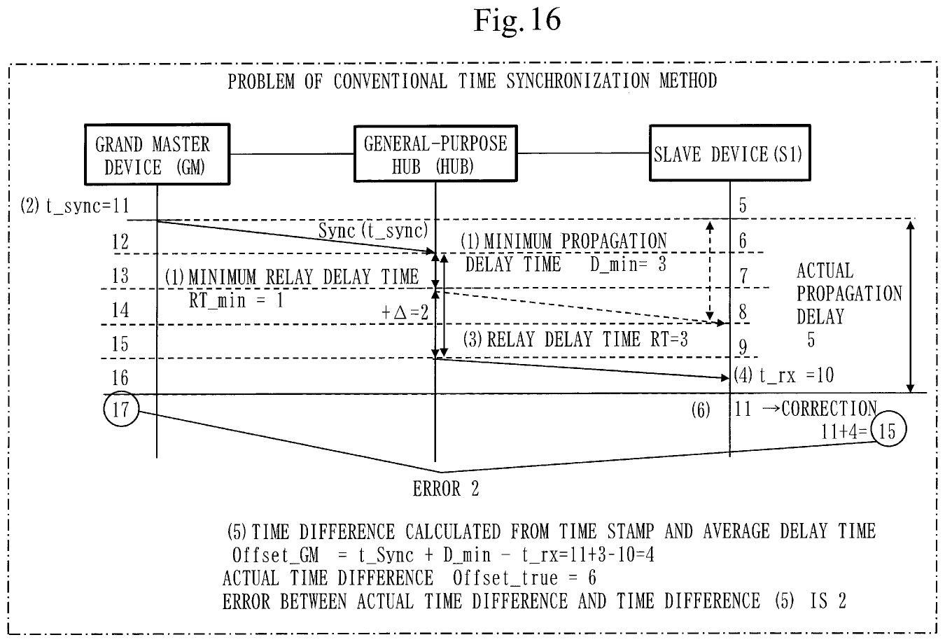

The general-purpose hub (HUB) 30 is a switching hub which is not compliant with time synchronization, and is identical with the general-purpose hub illustrated in FIG. 15 and FIG. 16. That is, a relay delay of the general-purpose hub (HUB) 30 is not constant. In FIG. 1, it is indicated that the relay delay of the general-purpose hub (HUB) 30 fluctuates by +A from an average relay delay acquired by IEEE1588 or IEEE802.1AS. Therefore, a fluctuation width of the relay delay +Δ needs to be added to an average time difference (Offset ave) acquired by IEEE1588 or IEEE802.1AS to acquire an offset value (Offset(N)).

In the present embodiment, both the grand master device (GM) 10 and the slave device (S1) 20 individually hold a free-run counter to measure time and a clock to measure time based on time ticked by the free-run counter. The free-run counter which the grand master device (GM) 10 holds is called a master counter hereinafter. The free-run counter which the slave device (S1) 20 holds is called a slave counter. The clock which the grand master device (GM) 10 holds is called a master clock. The clock which the slave device (S1) 20 holds is called a slave clock.

The slave device (S1) 20 corrects a value of the slave clock after time is delivered from the grand master device (GM) 10.

The master counter starts a count-up immediately after activation of the grand master device (GM) 10. Likewise, the slave counter starts a count-up immediately after activation of the slave device (S1) 20. In the master counter and the slave counter, a count value is not changed by a communication protocol. When the grand master device (GM) 10 is reset, the master counter is also reset. When the slave device (S1) 20 is reset, the slave counter is also reset.

The grand master device (GM) 10 transmits a Sync frame which is a time synchronization frame to the slave device (S1) 20. The grand master device (GM) 10, at transmission of the Sync frame, acquires a count value of the master counter and a value of the master clock, and stores the acquired count value of the master counter and the acquired value of the master clock in the Sync frame. Then, the grand master device (GM) 10 transmits the Sync frame in which the count value of the master counter and the value of the master clock is stored to the slave device (S1) 20. In FIG. 1, “t3(n)” is stored in the Sync frame as the count value of the master counter, and “t_sync(N)” is stored in the Sync frame as the value of the master clock. The slave device (S1) 20, at reception of the Sync frame, acquires a count value of the slave counter and a value of the slave clock. In FIG. 1, the slave device (S1) 20 acquires “t4(N)” as the count value of the slave counter and “t_rx(N)” as the value of the slave clock.

As described above, the Sync frame which is the time synchronization frame according to the present embodiment includes the count value of the master counter, and it is different from the Sync frame illustrated in FIG. 16.

Although illustration is omitted in FIG. 1, the slave device (S1) 20 transmits a DelayReq frame which is a propagation delay measurement request to the grand master device (GM) 10 as in FIG. 15. The slave device (S1) 20 retains a count value of the slave counter and a value of the slave clock at a time point of transmitting the DelayReq frame. The grand master device (GM) 10 retains a count value of the master counter and a value of the master clock at a time point of receiving the DelayReq frame. In addition, the grand master device (GM) 10 transmits a DelayResp frame which is a propagation delay measurement response to the slave device (S1) 20. The grand master device (GM) 10 stores a count value of the master counter and a value of the master clock at a time point of transmitting the DelayResp frame in the DelayResp frame. The slave device (S1) 20 retains a count value of the slave counter and a value of the slave clock at a time point of receiving the DelayResp frame. The slave device (S1) 20 also retains the count value of the master counter and the value of the master clock stored in the DelayResp frame.

In this way, the DelayReq frame and the DelayResp frame according to the present embodiment differ from the DelayReq frame and the DelayResp frame illustrated in FIG. 16.

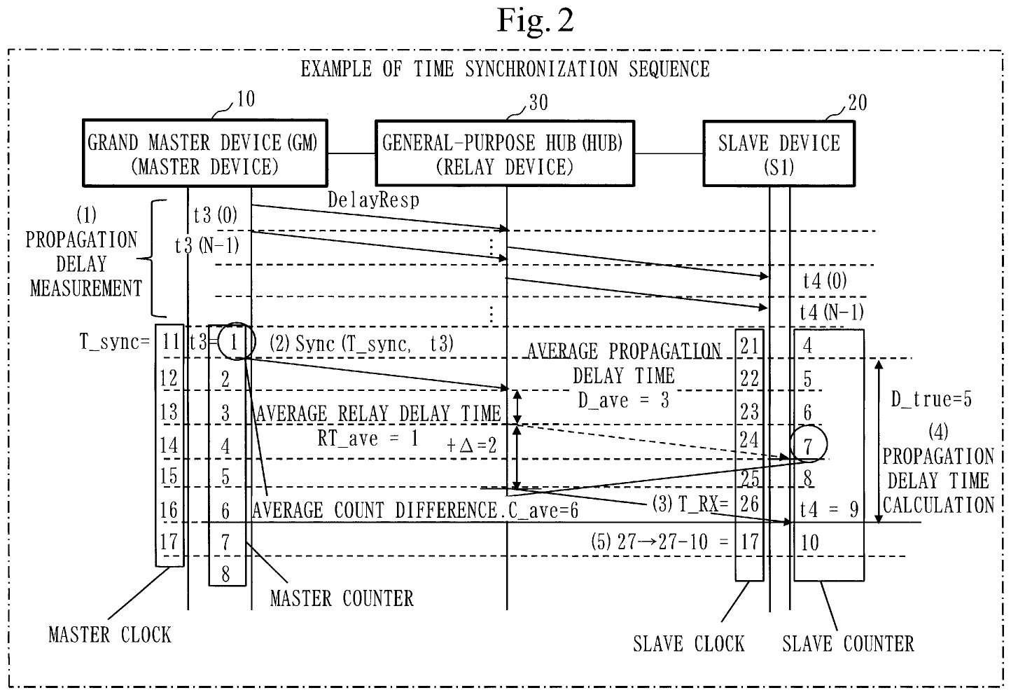

Next, a time synchronization sequence according to the present embodiment is described, referring to FIG. 2.

(1)-(5) below corresponds to (1)-(5) in FIG. 2.

(1) The slave device (S1) 20 repeatedly performs a propagation delay measurement with the grand master device (GM) 10 (procedure (1)-(6) in FIG. 16). However, the DelayReq frame and the DelayResp frame which are transmitted and received in FIG. 2 are, as described above, different from the DelayReq frame and the DelayResp frame illustrated in FIG. 16.

The slave device (S1) 20 measures, at the propagation delay measurement, the propagation delay time and a difference between the count value of the slave counter and the count value of the master counter. Then, the slave device (S1) 20 acquires an average value of the propagation delay time between the grand master device (GM) 10 and the slave device (S1) 20 (called as an average propagation delay D_ave hereinafter) from a plurality of past propagation delay measurements. The slave device (S1) 20 also acquires an average value of the difference between the count value of the master counter and the count value of the slave counter (called as an average count difference C_ave hereinafter) from the plurality of past propagation delay measurements.

Here, it is assumed that the average propagation delay D_ave and the average count difference C_ave below are acquired. The average propagation delay D_ave is a value of the propagation delay acquired from past propagation delay measurements, and corresponds to a measurement propagation delay value. The average count difference C_ave is a difference between the count value of the master counter and the count value of the slave counter corresponding to the average propagation delay D_ave, and is equivalent to a delay count difference.

[Formula 1]

Average Propagation Delay: D_ave=3 Expression 1

Average Count Difference: C_ave=Σₙ₌₀^{N-1}(t4(n)×RC_{GM_S1}−t3(n))/N=6 Expression 2

RC_{GM_S1} is a ratio between a clock frequency of the grand master device (GM) 10 and a clock frequency of the slave device (S1) 20.

In the present embodiment, to simplify calculation, it is assumed that a clock frequency difference between the slave device (S1) 20 and the grand master device (GM) 10 is small enough to ignore, and it is assumed to be RC_{GM_S1}=1. Since a calculation method of a clock ratio is the same as a method in IEEE 802.1AS, description of the calculation method of the clock ratio is omitted here.

It is also assumed that the clock frequency of the grand master device (GM) 10 is 1.

(2) The grand master device (GM) 10 stores a time stamp T_sync=11 of the master clock and a time stamp t3=1 of the master counter in the Sync frame, and transmits the Sync frame to the slave device (S1) 20. As described above, in IEEE1588 and IEEE802.1AS, a time stamp to be stored in the Sync frame is only the time stamp T_sync of the master clock, and the time stamp t3 of the master counter is not stored in the Sync frame. In this way, the Sync frame according to the present embodiment is different from the Sync frame in IEEE1588 and IEEE802.1AS in that the time stamp t3 of the master counter is stored.

The time stamp T_sync of the master clock to be stored in the Sync frame is also called as transmission time T_sync hereinafter. The time stamp t3 of the master counter to be stored in the Sync frame is also called as a transmission count value t3.

(3) The slave device (S1) 20 receives the Sync frame. Also, the slave device (S1) 20 retains a time stamp T_RX=26 of the slave clock and a time stamp t4=9 of the slave counter at a point of the reception of the Sync frame.

The time stamp T_RX of the slave clock at the point of the reception of the Sync frame is also called as reception time T_RX hereinafter. The time stamp t4 of the slave counter at the point of the reception of the Sync frame is also called as a reception count value t4.

(4) The slave device (S1) 20 calculates the propagation delay of the Sync frame in the following manner.

(a) Firstly, the slave device (S1) 20 subtracts an average count difference C_ave(=6) from a difference between the transmission count value t3(=1) and the reception count value t4(=9), and obtains a relay delay difference Δ. The relay delay difference Δ is a difference between a value of the relay delay by the general-purpose hub (HUB) 30 when relaying the Sync frame and a value of the relay delay contained in an average propagation delay D_ave.

Δ=t4×RC_{GM_S1}−t3−C_ave=(9−1−6)=2 Expression 3

(b) Next, the slave device (S1) 20 calculates a propagation delay D_true at the transmission of the Sync frame in the following manner.

D_true=D_ave+A*1/clock frequency of grand master device=3+2=5 Expression 4

(5) The slave device (S1) 20 calculates a time difference between the master clock and the slave clock as Offset(N), and corrects the time of the slave clock, using the value of Offset(N).

(a) The slave device (S1) 20 calculates Offset(N) in the following manner, using the transmission time T_sync(=11), the propagation delay D_true(=5), and the reception time T_RX(=26).

$$Offset ( N ) = T\_sync + D\_true - T\_RX = ( 11 + 5 - 26 ) = - 10 \qquad Expression 5$$

(b) The slave device (S1) 20 corrects the time of the slave clock, using the value of Offset(N), at timing of time point 27.

27+Offset(N)=27−10=17 Expression 6

By the above process, the time of the master clock in the grand master device (GM) 10 and the time of the slave clock in the slave device (S1) 20 are synchronized.

### ***Description of Configuration***

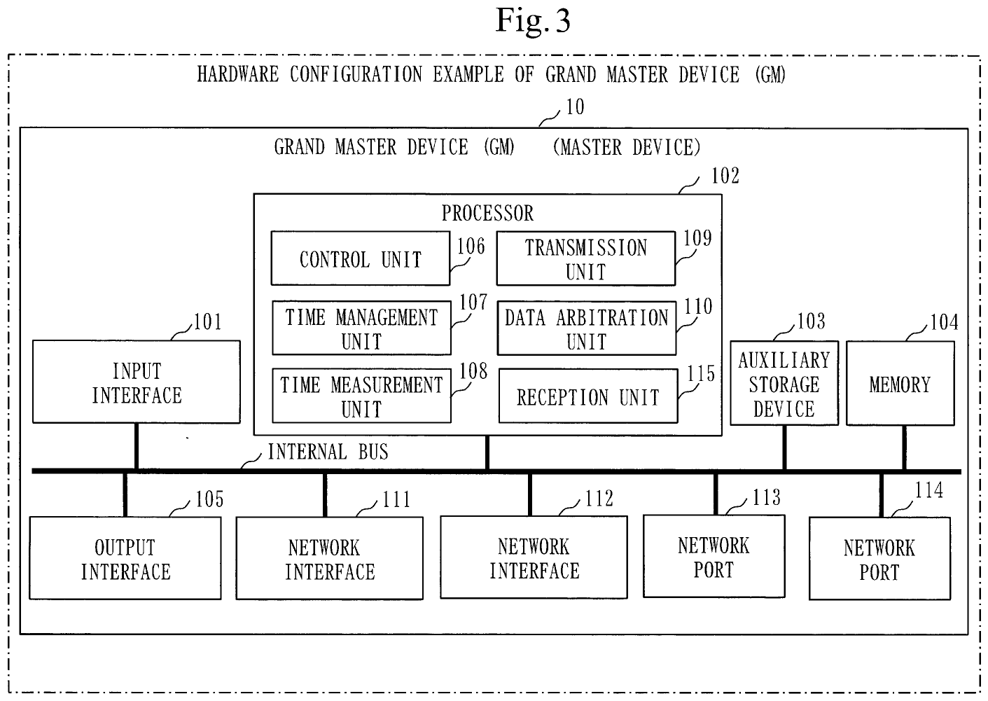

FIG. 3 illustrates a hardware configuration example of the grand master device (GM) 10 according to the present embodiment.

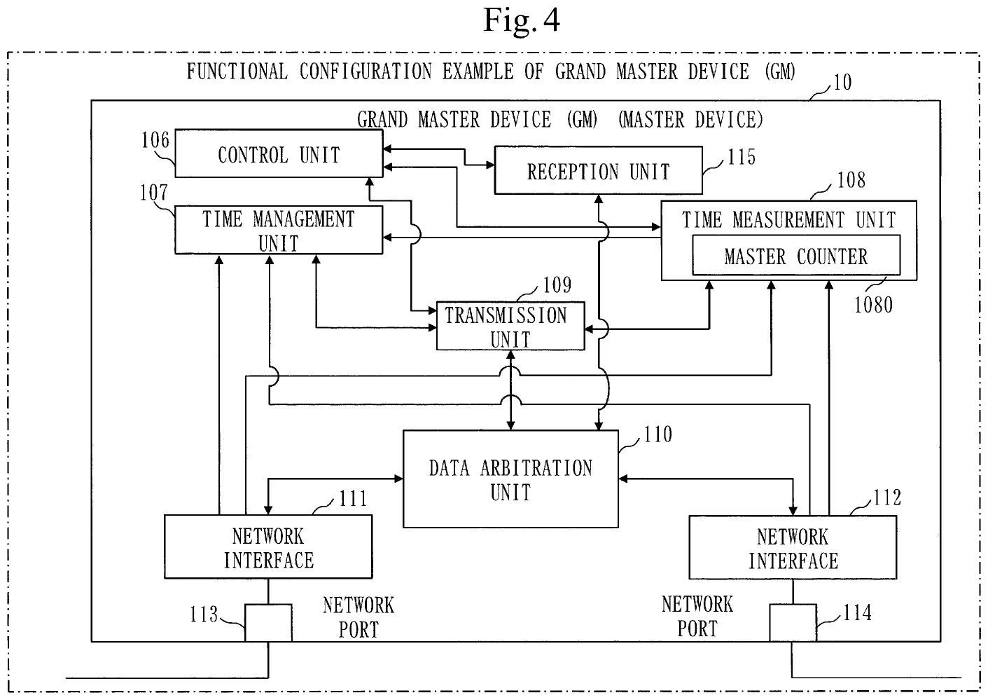

FIG. 4 illustrates a functional configuration example of the grand master device

(GM) 10 according to the present embodiment.

The grand master device (GM) 10 according to the present embodiment is a computer.

As illustrated in FIG. 3, the grand master device (GM) 10 includes an input interface 101, a processor 102, an auxiliary storage device 103, a memory 104, an output interface 105, a network interface 111, a network interface 112, a network port 113 and a network port 114, as hardware.

As illustrated in FIG. 4, the grand master device (GM) 10 includes a control unit 106, a time management unit 107, a time measurement unit 108, a transmission unit 109, a data arbitration unit 110 and a reception unit 115, as functional configurations.

In the auxiliary storage device 103, programs to realize functions of the control unit 106, the time management unit 107, the time measurement unit 108, the transmission unit 109, the data arbitration unit 110 and the reception unit 115 are stored.

These programs are loaded from the auxiliary storage device 103 to the memory 104. The processor 102 reads out these programs from the memory 104, and executes these programs. Then, the processor 102 performs operation of the control unit 106, the time management unit 107, the time measurement unit 108, the transmission unit 109, the data arbitration unit 110 and reception unit 115, which is described later.

FIG. 3 schematically illustrates a state in which the processor 102 is executing programs to realize functions of the control unit 106, the time management unit 107, the time measurement unit 108, the transmission unit 109, the data arbitration unit 110 and the reception unit 115.

The input interface 101 is used by a user of the grand master device (GM) 10 to input various kinds of instructions.

In the memory 104, the transmission time, the transmission count value and so forth are stored.

The output interface 105 is used to output data to an external storage medium of the grand master device (GM) 10.

The network interface 111 controls forwarding of a frame between the network port 113 and the time management unit 107, the time measurement unit 108 or the data arbitration unit 110.

The network interface 112 controls forwarding of a frame between the network port 114 and the time management unit 107, the time measurement unit 108 or the data arbitration unit 110.

The network port 113 and the network port 114 are physical connection ports with a network.

In FIG. 4, the control unit 106 performs total control of the grand master device (GM) 10.

Specifically, the control unit 106 notifies reception of the DelayReq frame to the time management unit 107 and the time measurement unit 108 when the reception unit 115 receives the DelayReq frame.

Also, the control unit 106 instructs the time management unit 107, the time measurement unit 108 and the transmission unit 109 to transmit the DelayResp frame.

The control unit 106 instructs the time management unit 107, the time measurement unit 108 and the transmission unit 109 to transmit the DelayResp frame when the reception of the DelayReq frame is notified by the reception unit 115.

The control unit 106 instructs the time management unit 107, the time measurement unit 108 and the transmission unit 109 to transmit the Sync frame. The control unit 106 instructs the time management unit 107, the time measurement unit 108 and the transmission unit 109 to transmit the Sync frame in a case where the number of times the propagation delay measurement (procedure (1)-(6) in FIG. 16) is executed exceeds a setting value. Note that the control unit 106 counts a transmission cycle of the Sync frame, and instructs the time management unit 107, the time measurement unit 108 and the transmission unit 109 to transmit the Sync frame at a designated cycle.

The time management unit 107 operates as the master clock. Specifically, the time management unit 107 retains time information. The time management unit 107 updates the time information when a count-up of a master counter 1080 is notified by the time measurement unit 108. The time management unit 107 updates time in a nanosecond order every time the count-up is notified from the time measurement unit 108.

For example, when an operation clock of the master counter 1080 is 125 MHz, the time management unit 107 updates time by every count-up of the master counter 1080 in a unit of 8 nanoseconds ( 1/125 MHz=8 ns).

Also, the time management unit 107 acquires current time when reception of the DelayReq frame is notified from the control unit 106, and stores the acquired current time in the memory 104.

Also, the time management unit 107 acquires current time when the time management unit 107 is instructed to transmit the DelayResp frame by the control unit 106, and notifies the transmission unit 109 of the acquired current time.

Also, the time management unit 107 acquires current time when the time management unit 107 is instructed to transmit the Sync frame by the control unit 106, and notifies the transmission unit 109 of the acquired current time.

The time measurement unit 108 includes the master counter 1080 which is a free-run counter. The master counter 1080 starts a count-up on activation of the grand master device (GM) 10. A value of the master counter 1080 is reset when the grand master device (GM) 10 is stopped.

The time measurement unit 108 notifies the time management unit 107 of the count-up of the master counter 1080 every time the master counter 1080 counts up.

Also, the time measurement unit 108 acquires a current count value of the master counter 1080 when reception of the DelayReq frame is notified from the control unit 106, and stores the acquired count value in the memory 104.

Also, the time measurement unit 108 acquires a current count value of the master counter 1080 when the time measurement unit 108 is instructed to transmit the DelayResp frame by the control unit 106, and notifies the transmission unit 109 of the acquired count value.

Also, the time measurement unit 108 acquires a current count value of the master counter 1080 when the time measurement unit 108 is instructed to transmit the Sync frame by the control unit 106, and notifies the transmission unit 109 of the acquired count value.

The transmission unit 109 generates a DelayResp frame when the transmission unit 109 is instructed to transmit the DelayResp frame by the control unit 106. Also, the transmission unit 109 stores the current time notified by the time management unit 107 in the DelayResp frame. In addition, the transmission unit 109 stores the current count value notified by the time measurement unit 108 in the DelayResp frame. Then, the transmission unit 109 transmits the DelayResp frame in which the current time and the current count value are stored to the slave device (S1) 20. More specifically, the transmission unit 109 outputs the DelayResp frame to the data arbitration unit 110. Also, the transmission unit 109 generates a Sync frame when the transmission unit 109 is instructed to transmit the Sync frame by the control unit 106. The transmission unit 109 stores the current time notified from the time management unit 107 in the Sync frame. In addition, the transmission unit 109 stores the current count value notified from the time measurement unit 108 in the Sync frame. Then, the transmission unit 109 transmits the Sync frame in which the current time and the current count value are stored to the slave device (S1) 20. More specifically, the transmission unit 109 outputs the Sync frame to the data arbitration unit 110.

The current time to be stored in the Sync frame is the transmission time described above. The current count value to be stored in the Sync frame is the transmission count value described above.

Regarding a communication frame received by the network interface 111 or the network interface 112, the data arbitration unit 110 determines a message type, determines whether or not the communication frame is normal, and determines an address.

Then, the data arbitration unit 110 forwards the communication frame to the reception unit 115 if the received communication frame is a communication frame addressed to the grand master device (GM) 10. For example, if the received communication frame is the DelayReq frame, the data arbitration unit 110 forwards the DelayReq frame to the reception unit 115.

On the other hand, if the received communication frame is a communication frame addressed to a different device, the data arbitration unit 110 performs a relaying process.

Also, the data arbitration unit 110 outputs the DelayResp frame and the Sync frame output from the transmission unit 109 to the network interface 111 or the network interface 112.

The reception unit 115 receives the DelayReq frame transmitted from the slave device (S1) 20. That is, the reception unit 115 receives the DelayReq frame forwarded from the data arbitration unit 110.

The reception unit 115 notifies the control unit 106 of reception of the DelayReq frame when it receives the DelayReq frame.

The network interface 111, the network interface 112, the network port 113 and the network port 114 in FIG. 4 are the same as those illustrated in FIG. 3.

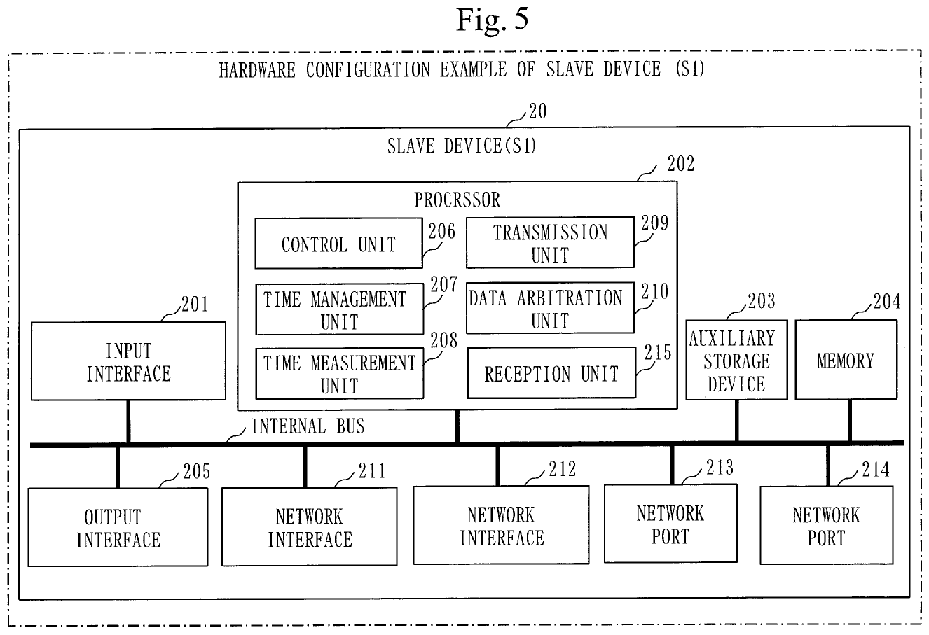

FIG. 5 illustrates a hardware configuration example of the slave device (S1) 20 according to the present embodiment.

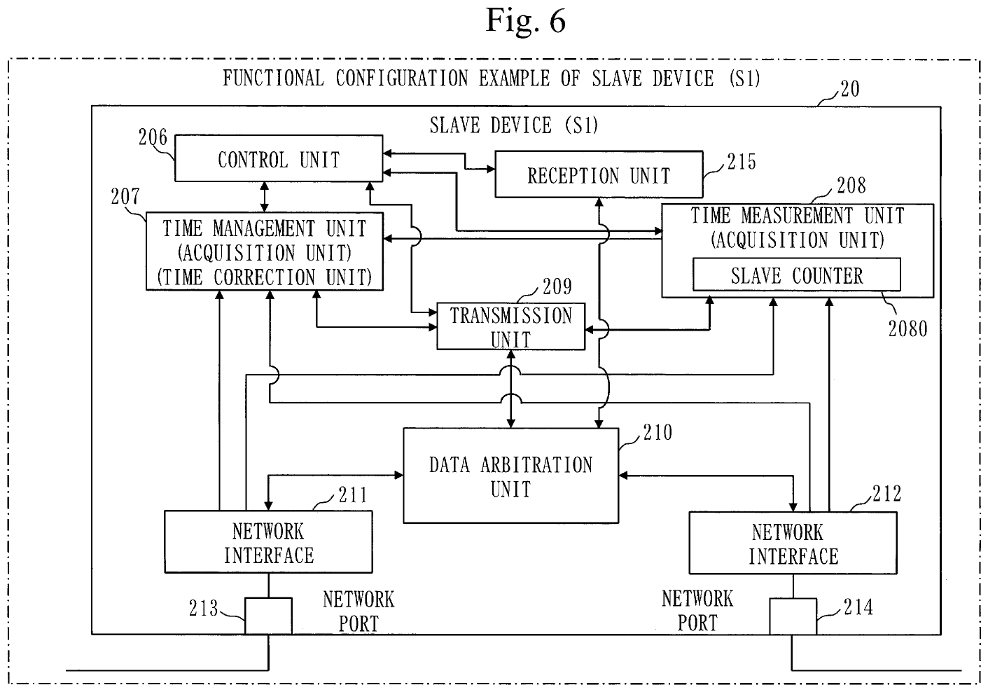

FIG. 6 illustrates a functional configuration example of the slave device (S1) 20 according to the present embodiment.

The slave device (S1) 20 according to the present embodiment is a computer.

As illustrated in FIG. 5, the slave device (S1) 20 includes an input interface 201, a processor 202, an auxiliary storage device 203, a memory 204, an output interface 205 a network interface 211, a network interface 212, a network port 213 and a network port 214, as hardware.

As illustrated in FIG. 6, the slave device (S1) 20 includes a control unit 206, a time management unit 207, a time measurement unit 208, a transmission unit 209, a data arbitration unit 210 and a reception unit 215, as functional configurations. In the auxiliary storage device 203, programs to realize functions of the control unit 206, the time management unit 207, the time measurement unit 208, the transmission unit 209, the data arbitration unit 210 and the reception unit 215 are stored.

These programs are loaded from the auxiliary storage device 203 to the memory 204. The processor 202 reads out these programs from the memory 204, and executes these programs. The processor 202 performs operation of the control unit 206, the time management unit 207, the time measurement unit 208, the transmission unit 209, the data arbitration unit 210 and the reception unit 215, which is described later.

FIG. 5 schematically illustrates a state in which the processor 202 is executing programs to realize functions of the control unit 206, the time management unit 207, the time measurement unit 208, the transmission unit 209, the data arbitration unit 210 and the reception unit 215.

The input interface 201 is used by a user of the slave device (S1) 20 to input various kinds of instructions.

In the memory 204, the transmission time, the transmission count value, the reception time, the reception count value, the average count difference C_ave, the average propagation delay D_ave and so forth are stored.

The output interface 205 is used to output data to an external storage medium of the slave device (S1) 20.

The network interface 211 controls forwarding of a frame between the network port 213 and the time management unit 207, the time measurement unit 208 or the data arbitration unit 210.

The network interface 212 controls forwarding of a frame between the network port 214 and the time management unit 207, the time measurement unit 208 or the data arbitration unit 210.

The network port 213 and the network port 214 are physical connection ports with a network.

In FIG. 6, the control unit 206 performs total control of the slave device (S1) 20.

Specifically, the control unit 206 instructs the transmission unit 209 to transmit the DelayReq frame. Also, the control unit 206 notifies the time management unit 207 and the time measurement unit 208 of transmission of the DelayReq frame.

Also, the control unit 206 notifies the time management unit 207 and the time measurement unit 208 of reception of the DelayResp frame when the reception unit 215 receives the DelayResp frame.

In addition, the control unit 206 notifies the time management unit 207 and the time measurement unit 208 of the reception of the Sync frame when the reception unit 215 receives the Sync frame.

Also, the control unit 206 instructs the time management unit 207 on time correction.

The time management unit 207 operates as the slave clock. Specifically, the time management unit 207 retains time information. The time management unit 207 updates the time information when a count-up of a slave counter 2080 is notified by the time measurement unit 208. The time management unit 207 updates time in a nanosecond order every time the count-up is notified from the time measurement unit 208.

For example, when the operation clock of the slave counter 2080 is 125 MHz, the time management unit 207 updates time by every count-up of the slave counter 2080 in the unit of 8 nanoseconds ( 1/125 MHz=8 ns).

The time management unit 207 acquires current time when transmission of the DelayReq frame is notified from the control unit 206, and stores the acquired current time in the memory 204.

In addition, the time management unit 207 acquires current time when reception of the DelayResp frame is notified from the control unit 206, and stores the acquired current time in the memory 204.

Also, the time management unit 207 acquires current time when reception of the Sync frame is notified from the control unit 206, and stores the acquired current time in the memory 204. The current time at reception of the Sync frame is the reception time described above.

Also, the time management unit 207 corrects time of the slave clock when instructed to correct time by the control unit 206.

The time management unit 207 corrects time of the slave clock, using the transmission time and the transmission count value acquired by the reception unit 215, the reception count value acquired by the time measurement unit 208, the reception time, the average propagation delay D_ave which is a measurement propagation delay value and the average count difference C_ave which is a delay count difference.

Specifically, the time management unit 207 calculates the relay delay difference Δ based on Expression 3 described above, and calculates the propagation delay D_true based on Expression 4 described above. The time management unit 207 calculates Offset(N) based on Expression 5 described above. Finally, the time management unit 207 corrects time of the slave clock based on Expression 6 described above.

The time management unit 207 corresponds to an acquisition unit and a time correction unit.

The time measurement unit 208 includes the slave counter 2080 which is a free-run counter. The slave counter 2080 starts a count-up on activation of the slave device (S1) 20. A value of the slave counter 2080 is reset when the slave device (S1) 20 is stopped.

The time measurement unit 208 notifies the time management unit 207 of the count-up of the slave counter 2080 every time the slave counter 2080 counts up.

Also, the time measurement unit 208 acquires a current count value of the slave counter 2080 when transmission of the DelayReq frame is notified by the control unit 206, and stores the acquired count value in the memory 204.

In addition, the time measurement unit 208 acquires a current count value of the slave counter 2080 when reception of the DelayResp frame is notified by the control unit 206, and stores the acquired count value in the memory 204.

The time measurement unit 208 acquires a current count value of the slave counter 2080 when reception of the Sync frame is notified by the control unit 206, and stores the acquired count value in the memory 204. The count value at the reception of the Sync frame is the reception count value.

The time measurement unit 208 corresponds to an acquisition unit together with the time management unit 207.

The transmission unit 209 generates a DelayReq frame when the transmission unit 209 is instructed to transmit the DelayReq frame by the control unit 206. Then, the transmission unit 209 transmits the DelayReq frame to the grand master device (GM) 10. More specifically, the transmission unit 209 outputs the DelayReq frame to the data arbitration unit 210.

Regarding a communication frame received by the network interface 211 or the network interface 212, the data arbitration unit 210 determines a message type, determines whether or not the communication frame is normal, and determines an address.

Then, the data arbitration unit 210 forwards the communication frame to the reception unit 215 if the received communication frame is a communication frame addressed to the slave device (S1) 20. For example, the data arbitration unit 210 forwards the DelayResp frame to the reception unit 215 if the received communication frame is the DelayResp frame. The data arbitration unit 210 forwards the Sync frame to the reception unit 215 if the received communication frame is the Sync frame.

On the other hand, if the received communication frame is a communication frame addressed to a different device, the data arbitration unit 210 performs a relaying process.

Also, the data arbitration unit 210 outputs the DelayReq frame output from the transmission unit 209 to the network interface 211 or the network interface 212.

The reception unit 215 receives the DelayResp frame transmitted from the grand master device (GM) 10. That is, the reception unit 215 receives the DelayResp frame forwarded by the data arbitration unit 210. The reception unit 215 acquires the time and the count value stored by the grand master device (GM) 10 from the received DelayResp frame. The reception unit 215 stores the acquired time and count value in the memory 204.

Also, the reception unit 215 notifies the control unit 206 of reception of the DelayResp frame when it receives the DelayResp frame.

In addition, the reception unit 215 receives the Sync frame transmitted by the grand master device (GM) 10. That is, the reception unit 215 receives the Sync frame forwarded from the data arbitration unit 210. The reception unit 215 acquires the time (transmission time) and the count value (transmission count value) stored by the grand master device (GM) 10 from the received Sync frame. Then, the reception unit 215 stores the acquired transmission time and the transmission count value in the memory 204.

The reception unit 215 notifies the control unit 206 of reception of the Sync frame when it receives the Sync frame.

The network interface 211, the network interface 212, the network port 213 and the network port 214 in FIG. 6 are the same as those illustrated in FIG. 5.

### ***Description of Operation***

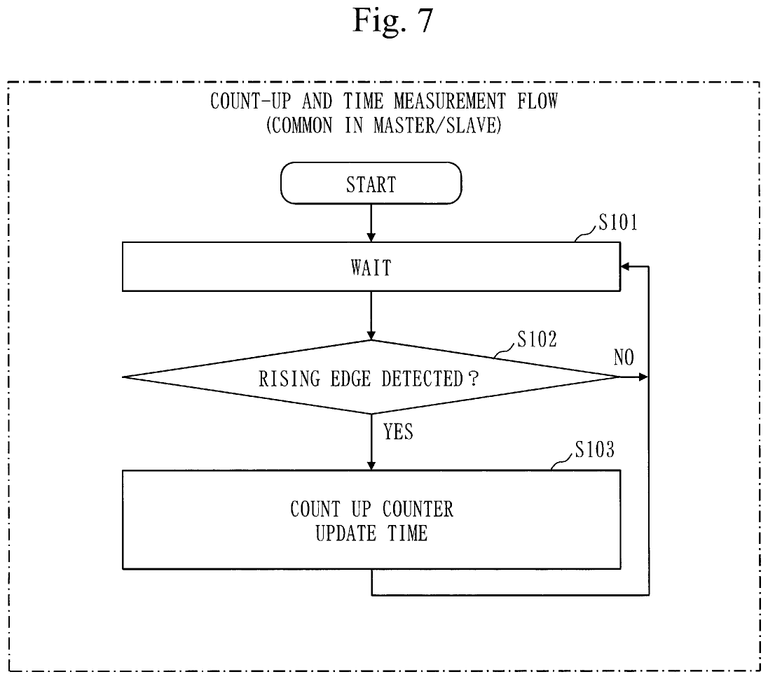

FIG. 7 illustrates a count-up and time measurement flow.

The count-up and time measurement flow illustrated in FIG. 7 is performed in common in the grand master device (GM) 10 and the slave device (S1) 20.

In the grand master device (GM) 10, the time measurement unit 108 waits until a rising edge of the operation clock of the master counter 1080 is detected (step S101).

When the rising edge is detected (YES in step S102), the time measurement unit 108 counts up the master counter 1080 (step S103). The time measurement unit 108 notifies the time management unit 107 of the count-up of the master counter 1080, and the time management unit 107 updates time (step S103).

As described above, when the operation clock of the master counter 1080 is 125 MHz, the time management unit 107 updates time by every count-up of the master counter 1080 in a unit of 8 nanoseconds ( 1/125 MHz=8 ns).

In the slave device (S1) 20, the time measurement unit 208 waits until a rising edge of the operation clock of the slave counter 2080 is detected (step S101). When the rising edge is detected (YES in step S102), the time measurement unit 208 counts up the slave counter 2080 (step S103). The time measurement unit 208 notifies the time management unit 207 of the count-up of the slave counter 2080, and the time management unit 207 updates time (step S103).

As described above, when the operation clock of the slave counter 2080 is 125 MHz, the time management unit 207 updates time by every count-up of the slave counter 2080 in a unit of 8 nanoseconds ( 1/125 MHz=8 ns).

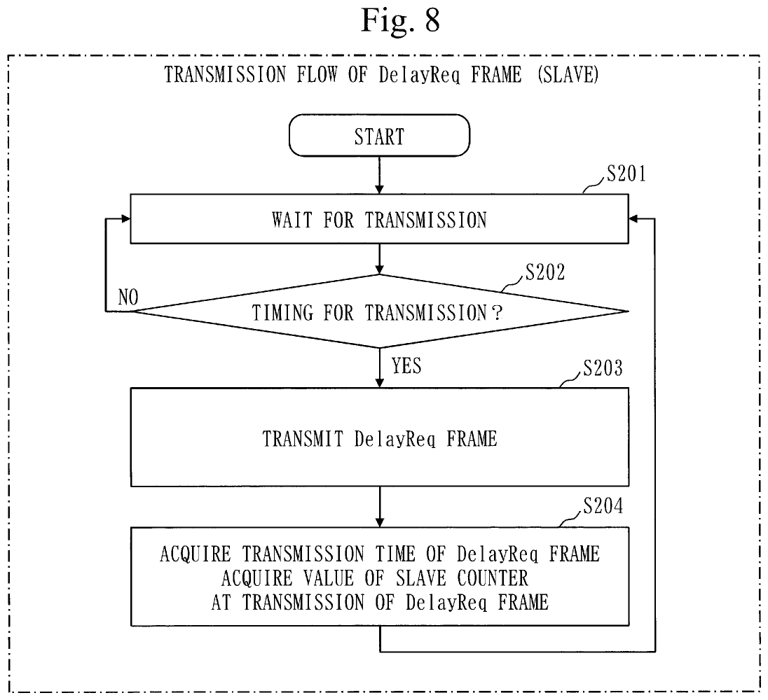

FIG. 8 illustrates a transmission flow of the DelayReq frame by the slave device (S1) 20.

The control unit 206 waits for timing for transmitting the DelayReq frame to come (step S201).

When the timing for transmitting the DelayReq frame comes (YES in step S202), the control unit 206 instructs the transmission unit 209 to transmit the DelayReq frame. The transmission unit 209 transmits the DelayReq frame to the grand master device (GM) 10 (step S203).

The control unit 206 notifies the time management unit 207 and the time measurement unit 208 of transmission of the DelayReq frame in parallel with a transmission instruction of the DelayReq frame to the transmission unit 209. The time management unit 207 acquires current time as transmission time of the DelayReq frame based on a notification from the control unit 206, and stores the acquired current time in the memory 204 (step S204). The time measurement unit 208 acquires a current count value of the slave counter 2080 as a count value of the slave counter 2080 at transmission of the DelayReq frame based on the notification from the control unit 206, and stores the acquired count value in the memory 204 (step S204).

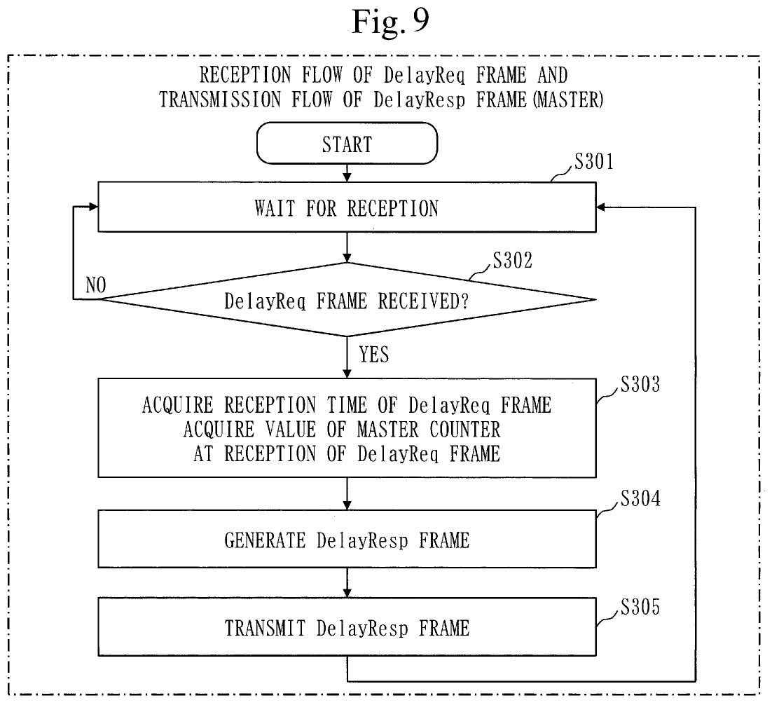

FIG. 9 illustrates a reception flow of the DelayReq frame and a transmission flow of the DelayResp frame by the grand master device (GM) 10.

The reception unit 115 waits for reception of the DelayReq frame (step S301), and on reception of the DelayReq frame by the reception unit 115 (YES in step S302), the time management unit 107 acquires reception time of the DelayReq frame (step S303). The time measurement unit 108 acquires a value of the master counter 1080 at reception of the DelayReq frame (step S303). More specifically, the reception unit 115 notifies the control unit 106 of reception of the DelayReq frame. The control unit 106 notifies the time management unit 107 and the time measurement unit 108 of reception of the DelayReq frame. The time management unit 107 acquires current time based on a notification from the control unit 106, and stores the acquired current time in the memory 104. The time measurement unit 108 acquires a current count value of the master counter 1080 based on the notification from the control unit 106, and stores the acquired count value in the memory 104.

The transmission unit 109 generates a DelayResp frame (step S304). More specifically, the control unit 106 instructs the time management unit 107, the time measurement unit 108 and the transmission unit 109 to transmit the DelayResp frame.

The time management unit 107 acquires current time, and notifies the transmission unit 109 of the acquired current time. The time measurement unit 108 acquires a current count value of the master counter 1080, and notifies the transmission unit 109 of the acquired count value. The transmission unit 109 generates a DelayResp frame, and stores the time notified from the time management unit 107 and the count value notified from the time measurement unit 108 in the generated DelayResp frame.

Then, the transmission unit 109 transmits the DelayResp frame generated in step S304 to the slave device (S1) 20 (step S305).

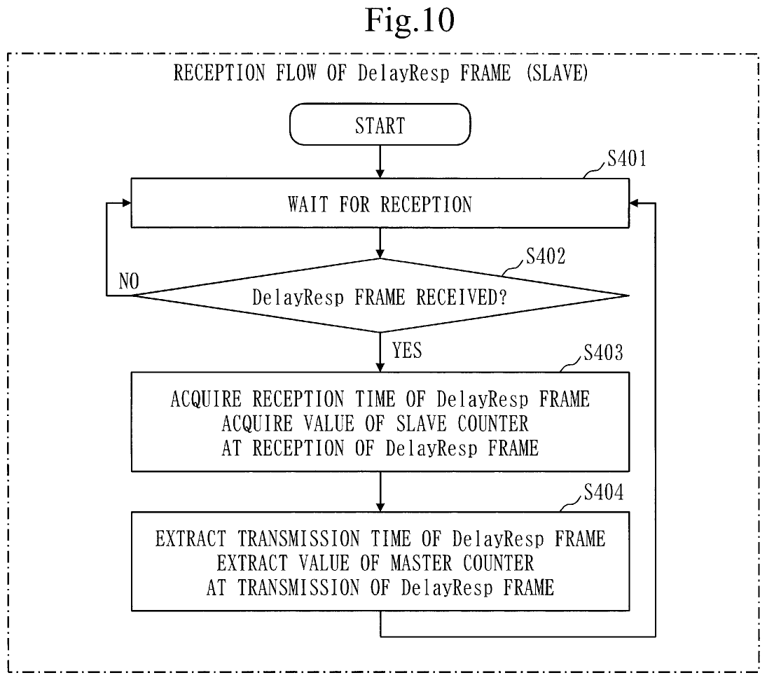

FIG. 10 illustrates a reception flow of the DelayResp frame by the slave device (S1) 20.

The reception unit 215 waits for reception of the DelayResp frame (step S401), and on reception of the DelayResp frame by the reception unit 215 (YES in step S402), the time management unit 207 acquires reception time of the DelayResp frame (step S403). The time measurement unit 208 acquires a value of the slave counter 2080 at reception of the DelayResp frame (step S403). More specifically, the reception unit 215 notifies the control unit 206 of reception of the DelayResp frame. The control unit 206 notifies the time management unit 207 and the time measurement unit 208 of reception of the DelayResp frame. The time management unit 207 acquires current time based on a notification from the control unit 206, and stores the acquired current time in the memory 204. The time measurement unit 208 acquires a current count value of the slave counter 2080 based on the notification from the control unit 206, and stores the acquired count value in the memory 204.

The reception unit 215 extracts the transmission time of the DelayResp frame and the value of the master counter 1080 at transmission of the DelayResp frame, from the DelayResp frame (step S404). Then, the reception unit 215 stores the extracted transmission time and the value of the master counter 1080 in the memory 204.

In FIG. 10, it is illustrated that step S404 is performed after step S403, however, step S403 and step S404 may be performed concurrently.

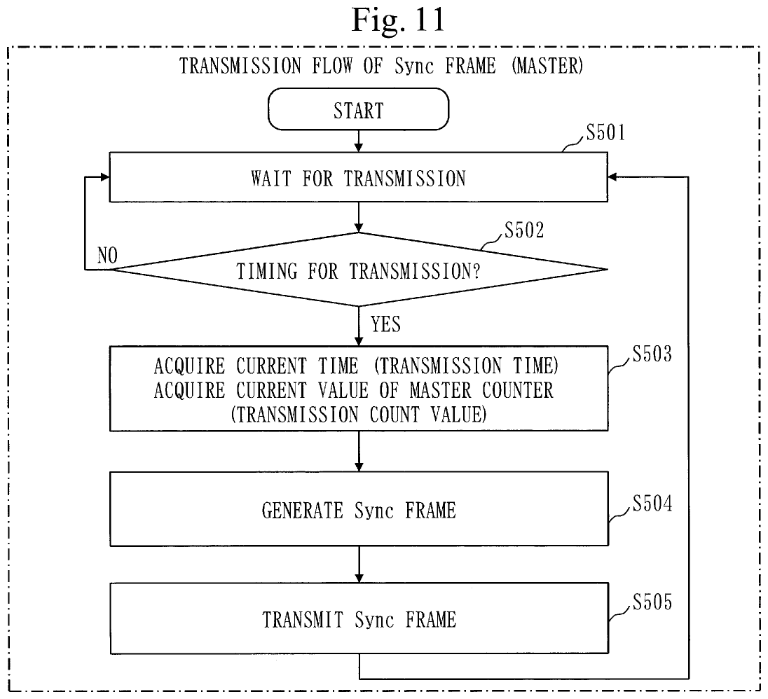

FIG. 11 illustrates a transmission flow of the Sync frame by the grand master device (GM) 10.

The control unit 106 waits for timing for transmitting the Sync frame to come (step S501).

When the timing for transmitting the Sync frame comes (YES in step S502), the control unit 106 instructs the time management unit 107, the time measurement unit 108 and the transmission unit 109 to transmit the Sync frame. The time management unit 107 acquires current time, and notifies the transmission unit 109 of the acquired current time (step S503). The time measurement unit 108 acquires a current count value of the master counter 1080, and notifies the transmission unit 109 of the acquired count value (step S503).

The transmission unit 109 generates a Sync frame, and stores the time notified from the time management unit 107 and the count value notified from the time measurement unit 108 in the generated Sync frame (step S504).

Then, the transmission unit 109 transmits the Sync frame to the slave device (S1) 20 (step S505).

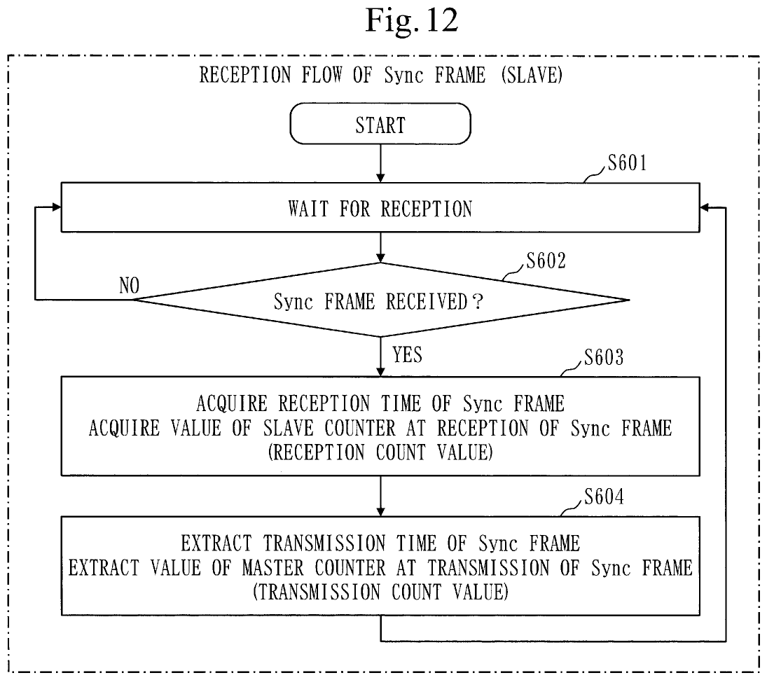

FIG. 12 illustrates a reception flow of the Sync frame by the slave device (S1) 20.

The reception unit 215 waits for reception of the Sync frame (step S601), and on reception of the Sync frame by the reception unit 215 (YES in step S602), the time management unit 207 acquires reception time of the Sync frame (step S603). The time measurement unit 208 acquires a value of the slave counter 2080 at reception of the Sync frame (reception count value) (step S603). More specifically, the reception unit 215 notifies the control unit 206 of reception of the Sync frame. The control unit 206 notifies the time management unit 207 and the time measurement unit 208 of reception of the Sync frame. The time management unit 207 acquires current time based on a notification from the control unit 206, and stores the acquired current time in the memory 204. The time measurement unit 208 acquires a current count value of the slave counter 2080 based on the notification from the control unit 206, and stores the acquired count value in the memory 204.

The reception unit 215 extracts the transmission time of the Sync frame and the value of the master counter 1080 at transmission of the Sync frame (transmission count value) from the Sync frame (step S604). Then, the reception unit 215 stores the extracted transmission time and the value of the master counter 1080 in the memory 204.

In FIG. 12, it is illustrated that step S604 is performed after step S603, however, step S603 and step S604 may be performed concurrently.

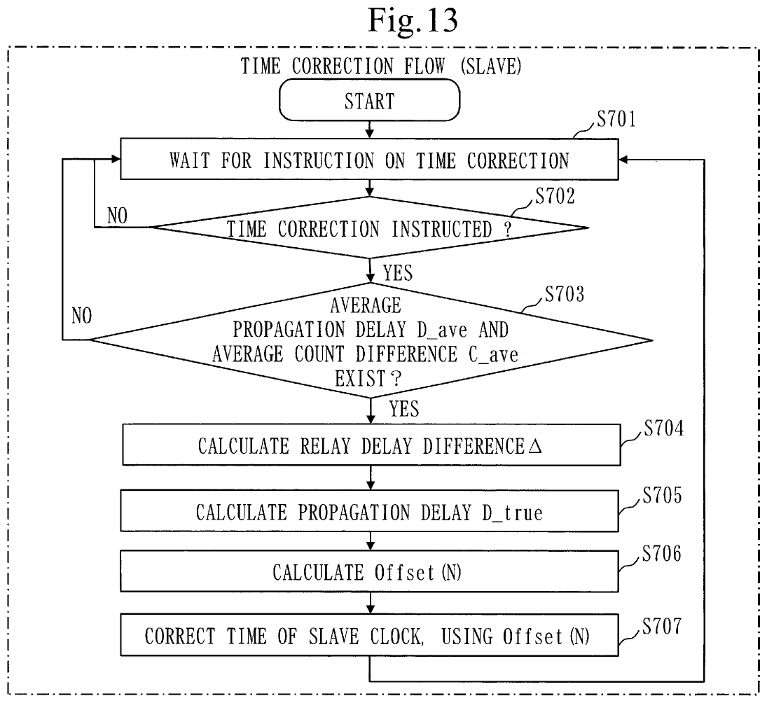

FIG. 13 illustrates a time correction flow of the slave device (S1) 20.

The time management unit 207 waits for an instruction on time correction from the control unit 206 (step S701).

When the time management unit 207 is instructed to correct time by the control unit 206 (YES in step S702), the time management unit 207 determines whether or not the average propagation delay D_ave and the average count difference C_ave exist in the memory 204 (step S703).

If the average propagation delay D_ave and the average count difference C_ave do not exist in the memory 204 (NO in step S703), a process returns to step S701.

If the average propagation delay D_ave and the average count difference C_ave exist in the memory 204 (YES in step S703), the time management unit 207 calculates a relay delay difference Δ (step S704). Specifically, the time management unit 207 calculates the relay delay difference Δ according to Expression 3 described above.

Next, the time management unit 207 calculates the propagation delay D_true (step S705). Specifically, the time management unit 207 calculates the propagation delay D_true according to Expression 4 described above.

Next, the time management unit 207 calculates Offset(N) (step S706). Specifically, the time management unit 207 calculates Offset(N) according to Expression 5 described above.

Finally, the time management unit 207 corrects time of the slave clock, using Offset(N) (step S707). Specifically, the time management unit 207 corrects time according to Expression 6 described above.

### ***Description of Effect of Embodiment***

As described above, according to the present embodiment, it is possible to correct a time difference between the grand master device (GM) 10 and the slave device (S1) 20 which occurs from a fluctuation of delay time in a transmission line. That is, according to the present embodiment, even if a switching hub which is not compliant to time synchronization is incorporated in a network, accurate time synchronization can be realized between the grand master device (GM) 10 and the slave device (S1) 20.

### ***Description of Hardware Configuration***

Finally, supplemental description of hardware configuration is made.

Each of the processor 102 illustrated in FIG. 3 and the processor 202 illustrated in FIG. 5 is an IC (Integrated Circuit) which performs processing.

Each of the processor 102 and the processor 202 is a CPU (Central Processing Unit), a DSP (Digital Signal Processor), or the like.

Each of the memory 104 illustrated in FIG. 3 and the memory 204 illustrated in FIG. 5 is a RAM (Random Access Memory).

Each of the auxiliary storage device 103 illustrated in FIG. 3 and the auxiliary storage device 203 illustrated in FIG. 5 is a ROM (Read Only Memory), a flash memory, an HDD (Hard Disk Drive), or the like.

Each of the network interface 111 and the network interface 112 illustrated in FIG. 3 and the network interface 211 and the network interface 212 illustrated in FIG. 5 includes a receiver to receive data and a transmitter to transmit data.

Each of the network interface 111, the network interface 112, the network interface 211, and the network interface 212 is, for example, a communication chip or a NIC (Network Interface Card).

An OS (Operating System) is also stored in the auxiliary storage device 103.

At least part of the OS is executed by the processor 102.

While executing at least part of the OS, the processor 102 executes programs for realizing the functions of the control unit 106, the time management unit 107, the time measurement unit 108, the transmission unit 109, the data arbitration unit 110 and the reception unit 115.

With the processor 102 executing the OS, task management, memory management, file management, communication control, and so forth are performed.

An OS (Operating System) is also stored in the auxiliary storage device 203.

At least part of the OS is executed by the processor 202.

While executing at least part of the OS, the processor 202 executes programs for realizing the functions of the control unit 206, the time management unit 207, the time measurement unit 208, the transmission unit 209, the data arbitration unit 210 and the reception unit 215.

With the processor 202 executing the OS, task management, memory management, file management, communication control, and so forth are performed.

At least any of information, data, a signal value and a variable value indicating the results of processes of the control unit 106, the time management unit 107, the time measurement unit 108, the transmission unit 109, the data arbitration unit 110 and the reception unit 115 is stored in at least any of the auxiliary storage device 103, the memory 104 and a register and cache memory in the processor 102.

Also, programs for realizing the functions of the control unit 106, the time management unit 107, the time measurement unit 108, the transmission unit 109, the data arbitration unit 110 and the reception unit 115 may be stored in a portable storage medium such as a magnetic disk, flexible disk, optical disk, compact disk, Blu-ray (a registered trademark) disc, or DVD.

At least any of information, data, a signal value and a variable value indicating the results of processes of the control unit 206, the time management unit 207, the time measurement unit 208, the transmission unit 209, the data arbitration unit 210 and the reception unit 215 is stored in at least any of the auxiliary storage device 203, the memory 204, a register and cache memory in the processor 202.

Also, programs for realizing the functions of the control unit 206, the time management unit 207, the time measurement unit 208, the transmission unit 209, the data arbitration unit 210 and the reception unit 215 may be stored in a portable storage medium such as a magnetic disk, flexible disk, optical disk, compact disk, Blu-ray (a registered trademark), or DVD.

Also, the “units” in the control unit 106, the time management unit 107, the time measurement unit 108, the transmission unit 109, the data arbitration unit 110 and the reception unit 115 may be read as “circuits”, “steps”, “procedures”, or “processes”.

Also, the grand master device (GM) 10 may be realized by an electronic circuit such as a logic IC (Integrated Circuit), GA(Gate Array), ASIC(Application Specific Integrated Circuit), or FPGA(Field-Programmable Gate Array).

Also, the “units” in the control unit 206, the time management unit 207, the time measurement unit 208, the transmission unit 209, the data arbitration unit 210 and the reception unit 215 may be read as “circuits”, “steps”, “procedures”, or “processes”.

Also, the slave device (S1) 20 may be realized by an electronic circuit such as a logic IC, GA, ASIC, or FPGA.

In this specification, the processor, the memory, a combination of the processor and the memory, and the above electronic circuits are referred to as “processing circuitry”.

That is, the processor, the memory, the combination of processor and memory, and the electronic circuits are specific examples of “processing circuitry”.

### REFERENCE SIGNS LIST

10: grand master device (GM), 20: slave device (S1), 30: general-purpose hub (HUB), 101: input interface, 102: processor, 103: auxiliary storage device, 104: memory, 105: output interface, 106: control unit, 107: time management unit, 108: time measurement unit, 109: transmission unit, 110: data arbitration unit, 111: network interface, 112: network interface, 113: network port, 114: network port, 115: reception unit, 201: input interface, 202: processor, 203: auxiliary storage device, 204: memory, 205: output interface, 206: control unit, 207: time management unit, 208: time measurement unit, 209: transmission unit, 210: data arbitration unit, 211: network interface, 212: network interface, 213: network port, 214: network port, 215: reception unit, 1080: master counter, 2080: slave counter.

1. A communication system comprising:
a master device and a slave device connected via a relay device whose relay delay is not constant,
wherein the master device includes
a master counter which is a free-run counter; and
first processing circuitry, at timing for transmitting a time synchronization frame for time synchronization, to acquire current time as transmission time of the time synchronization frame, to acquire a count value of the master counter as a transmission count value, to store the transmission time and the transmission count value in the time synchronization frame, and to transmit the time synchronization frame to the slave device,
wherein the slave device includes
a slave counter which is a free-run counter independent from the master counter; and
second processing circuitry
to receive the time synchronization frame;
to acquire reception time of the time synchronization frame and a reception count value which is a count value of the slave counter at the reception time; and
to correct time of the slave device, using the transmission time, the reception time, a transmission/reception-count difference, a measurement propagation delay value and a delay count difference, the transmission/reception-count difference being a difference between the transmission count value and the reception count value, the measurement propagation delay value being a value of propagation delay acquired from a past measurement, the delay count difference being obtained from a count value of the master counter and a count value of the slave counter which correspond to the measurement propagation delay value, and
wherein the second processing circuitry calculates, as a relay delay difference, a difference between a value of relay delay by the relay device when relaying the time synchronization frame and a value of relay delay included in the measurement propagation delay value, based on the transmission/reception-count difference and the delay count difference;
calculates a value of propagation delay at transmission of the time synchronization frame, using the calculated relay delay difference and the measurement propagation delay value;
calculates, as an offset value, a difference between the time of the master device and the time of the slave device, using the calculated value of propagation delay at transmission of the time synchronization frame, the transmission time and the reception time; and
corrects the time of the slave device, using the calculated offset value.

2-4. (canceled)

5. The communication system according to claim 1,
wherein the second processing circuitry calculates the relay delay difference based on the transmission/reception-count difference, the delay count difference, a clock frequency of the master device and a clock frequency of the slave device.

6. The communication system according to claim 1,
wherein the second processing circuitry corrects the time of the slave device, using an average value of a plurality of values of propagation delay acquired in a plurality of past measurements as the measurement propagation delay value.

7. The communication system according to claim 6,
wherein the second processing circuitry uses, as the measurement propagation delay value, the average value of the plurality of values of propagation delay measured by transmitting and receiving the frames to and from the master device.

8. (canceled)

9. A slave device connected to a master device via a relay device whose relay delay is not constant, the master device including a master counter which is a free-run counter, and at a timing for transmitting a time synchronization frame for time synchronization, acquiring current time as transmission time of the time synchronization frame, acquiring a count value of the master counter as a transmission count value, storing the transmission time and the transmission count value in the time synchronization frame, and transmitting the time synchronization frame in which the transmission time and the transmission count value are stored, the slave device comprising:
a slave counter which is a free-run counter independent from the master counter; and
processing circuitry
to receive the time synchronization frame transmitted from the master device;
to acquire reception time of the time synchronization frame and a reception count value which is a count value of the slave counter at the reception time; and
to correct time of the slave device, using the transmission time, the reception time, a transmission/reception-count difference, a measurement propagation delay value and a delay count difference, the transmission/reception-count difference being a difference between the transmission count value and the reception count value, the measurement propagation delay value being a value of propagation delay acquired from a past measurement, the delay count difference being obtained from a count value of the master counter and a count value of the slave counter which correspond to the measurement propagation delay value,
wherein the processing circuitry calculates, as a relay delay difference, a difference between a value of relay delay by the relay device when relaying the time synchronization frame and a value of relay delay included in the measurement propagation delay value, based on the transmission/reception-count difference and the delay count difference;
calculates a value of propagation delay at transmission of the time synchronization frame, using the calculated relay delay difference and the measurement propagation delay value;
calculates, as an offset value, a difference between the time of the master device and the time of the slave device, using the calculated value of propagation delay at transmission of the time synchronization frame, the transmission time and the reception time; and
corrects the time of the slave device, using the calculated offset value.

10-12. (canceled)

13. The slave device according to claim 9,
wherein the processing circuitry calculates the relay delay difference based on the transmission/reception-count difference, the delay count difference, a clock frequency of the master device and a clock frequency of the slave device.

14. The slave device according to claim 9,
wherein the processing circuitry corrects the time of the slave device, using an average value of a plurality of values of propagation delay acquired in a plurality of past measurements as the measurement propagation delay value.

15. The slave device according to claim 14,
wherein the processing circuitry uses, as the measurement propagation delay value, the average value of the plurality of values of propagation delay measured by transmitting and receiving the frames to and from the master device.
